(19) United States
(12) Patent Application Publication
(10) Pub. No.: US 2008/0292803 A1
(43) Pub. Date: Nov. 27, 2008

(54) Low conductivity, thermal barrier coating system for ceramic matrix composite (CMC) articles

(75) Inventors: Bangalore A. Nagaraj, West Chester, OH (US); Irene Spitsberg, Loveland, OH (US); Christine Govern, Cincinnati, OH (US); Brian Thomas Hazel, Cincinnati, OH (US)

Correspondence Address: HARRINGTON & SMITH, PC, 4 RESEARCH DRIVE, Suite 202, SHELTON, CT, 06484-6212, US

(73) Assignee: General Electric Company

(21) Appl. No.: 11/903,096

(22) Filed: Sep. 20, 2007

Related U.S. Application Data
(62) Division of application No. 11/170,469, filed on Jun. 28, 2005.

(51) Int. Cl. B05D 1/36

(52) U.S. Cl. 427/419.2

(57) ABSTRACT

In accordance with an embodiment of the invention, a thermal barrier coating for inclusion in a thermal barrier coating/environmental barrier coating system (TBC/EBC system) for use on a silicon based substrate is disclosed. The thermal barrier coating comprising up to about 9 mol percent of a stabilizer and up to 91 mol percent of primary oxide selected from the group consisting of zirconia, hafnia and mixtures thereof. The stabilizer comprises: a first metal oxide selected from the group consisting of yttria, calcia, ceria, scandia, magnesia, india and mixtures thereof, a second metal oxide of a trivalent metal atom selected from the group consisting of lanthana, gadolinia, neodymia, samaria, dysprosia, ytterbia, erbia, and mixtures thereof. The first metal oxide is in an amount of from about 3 to about 5 mol %, the second metal oxide is in an amount of from about 0.25 to about 6 mol %.

### GOVERNMENT RIGHTS

This invention was made in part under contract number N00421-00-0536 awarded by the Government (Navy). Accordingly, the Government has certain rights in this invention.

### FIELD OF THE INVENTION

This invention relates to coating systems suitable for protecting components exposed to high-temperature environments, such as the hostile thermal environment of a gas turbine engine. More particularly, this invention is directed to a thermal/environmental barrier coating system for a substrate formed of a material containing silicon.

### BACKGROUND OF THE INVENTION

Higher operating temperatures for gas turbine engines are continuously sought in order to increase their efficiency. However, as operating temperatures increase, the high temperature durability of the components of the engine must correspondingly increase. Materials containing silicon, particularly those with silicon carbide (SiC) as a matrix material or a reinforcing material, are currently being used for high temperature applications, such as for combustor and other hot section components of gas turbine engines, because of the excellent capacity of these silicon materials to operate at higher temperatures.

However, it has been found that silicon containing substrates can recede and lose mass as a result of a formation volatile Si species, particularly Si(OH)ₓ and SiO when exposed to high temperature, aqueous environments. For example, silicon carbide when exposed to a lean fuel environment of approximately 1 ATM pressure of water vapor at about 2192° F. (1200° C.) may exhibit weight loss and recession at a rate of approximately 152.4 microns (6 mils) per 1000 hrs. It is believed that the process involves oxidation of the silicon carbide to form silica on the surface of the silicon carbide followed by reaction of the silica with steam to form volatile species of silicon such as Si(OH)ₓ.

Methods, such as described in U.S. Pat. No. 6,410,148, the disclosure of which is hereby incorporated by reference in its entirety, have dealt with the above problem concerning use of the silicon based substrates by providing a sufficient environmental barrier coating (EBC) for silicon containing substrates which inhibits the formation of volatile silicon species, Si(OH)ₓ and SiO. This reduces recession and mass loss, and provides thermal protection to and closely matches the thermal expansion of the silicon based substrate. U.S. Pat. No. 6,410,148 describes using an EBC comprising barium strontium aluminosilicate (BSAS) to protect the silicon based substrate. In further embodiments, an intermediate layer is described therein for providing adhesion between the substrate and/or to prevent reactions between the B SAS barrier layer and the substrate. Still further a bond layer between the intermediate layer and the substrate may also be provided which includes silicon.

Although barium-strontium-aluminosilicate (BSAS) coatings have been shown to provide excellent environmental protection and good thermal barrier protection to silicon based components exposed to temperatures of up to about 2500° F. (1371° C.), these systems may encounter problems when the EBC and the component are subjected to higher operating temperatures. In particular, for application temperatures approaching the melting temperature of B SAS (about 1700° C.), these BSAS protective coatings may require a thermal-insulating top coat. U.S. Pat. No. 5,985,970 to Spitsberg et al., the disclosure of which is hereby incorporated by reference in its entirety, mentions the use of a top coat comprising 7% ytrria stabilized zirconia (7% YSZ) as a top layer to a B SAS bond coat for solving this problem.

Further still, as application temperatures increase beyond the thermal capability of a Si-containing material (limited by a melting temperature of about 2560° F. (about 1404° C.) for silicon), conventional TBC's may not adequately protect the underlying component. Rather, under elevated temperatures approaching 3000° F. (1649° C.) or greater, still thicker coatings capable of withstanding higher thermal gradients may be required. However, as coating thickness increases, strain energy due to the CTE mismatch between individual coating layers and the substrate increases as well, which can cause debonding and spallation of the coating system. In order to combat this problem, U.S. Pat. No. 6,444,335 to Wang, et al., the disclosure of which is hereby incorporated by reference in its entirety, describes adding a CTE transition layer between the EBC, e.g. BSAS and the TBC, YSZ for ensuring adherence of the TBC layer to the EBC.

While the transition layer/EBC/TBC combination of the '335 patent was an improvement over prior methods for running components at higher operating temperatures between about 2500° F. (1371° C.) to 3000° F. (1649° C.), the TBC/EBC system of the '335 patent when subjected to higher operating temperatures may not provide optimum thermal and/or environmental protection to their underlying silicon based component.

After exposure to temperatures of about 3000° F. (1649° C.) and above, the columns of the TBC's (YSZ) of some prior systems may become subject to sintering, wherein gaps between the columns may result. When the above sintering occurs, the TBC layer may have limited protective capability and provide a direct route of attack to the EBC and/or underlayers of the TBC. For example, cracks may continue into the underlying EBC and sometimes through the BSAS layer when the TBC has been subject to sintering or spallation.

Accordingly, there is a need in the art for an improved TBC for use in a TBC/EBC system which provides sufficient thermal and environmental protection to underlying silicon based substrate components operating at temperatures of about 3000° F. (1649° C.) or higher for short or extended periods of time. In particular, an improved TBC is needed which has low thermal conductivity, improved resistance to sintering and improved phase stability for use with a sufficient EBC for coating a silicon based substrate. This TBC should also have reduced thickness and weight, as well as improved mechanical properties and spallation resistance at temperatures between about 2500-3000° F. (1371-1649° C.) or greater.

### BRIEF DESCRIPTION OF THE INVENTION

In accordance with an embodiment of the invention, a thermal barrier coating for inclusion in a thermal barrier coating/environmental barrier coating system (TBC/EBC system) for use on a silicon based substrate is disclosed. The thermal barrier coating includes up to about 9 mol percent of a stabilizer and up to 91 mol percent of primary oxide selected from the group consisting of zirconia, hafnia and mixtures thereof. The stabilizer comprises: a first metal oxide selected from the group consisting of yttria, calcia, ceria, scandia, magnesia, india and mixtures thereof, and a second metal oxide of a trivalent metal atom selected from the group consisting of lanthana, gadolinia, neodymia, samaria, dysprosia, ytterbia, erbia, and mixtures thereof. The first metal oxide is in amount of from about 3 to about 5 mol % and the second metal oxide is in an amount of from about 0.25 to about 6 mol %.

In accordance with a further embodiment of the invention, an article is disclosed. The article comprises a substrate comprising silicon; an environmental barrier coating (EBC) overlying the substrate; and a thermal barrier coating (TBC) on the environmental barrier coating. The thermal barrier coating includes up to about 9 mol percent of a stabilizer and up to 91 mol percent of primary oxide selected from the group consisting of zirconia, hafnia and mixtures thereof. The stabilizer comprises: a first metal oxide selected from the group consisting of yttria, calcia, ceria, scandia, magnesia, india and mixtures thereof, and a second metal oxide of a trivalent metal atom selected from the group consisting of lanthana, gadolinia, neodymia, samaria, dysprosia, ytterbia, erbia, and mixtures thereof. The first metal oxide is in amount of from about 3 to about 5 mol % and the second metal oxide is in an amount of from about 0.25 to about 6 mol %.

In accordance with another embodiment of the invention, a gas turbine engine component formed of a silicon containing material and having a thermal/environmental barrier coating system on a surface thereof is disclosed. The thermal/environmental barrier coating system comprises: an environmental barrier coating (EBC) comprising a bond layer, a first layer and a second layer; said bond layer is located on the surface between the first layer and the substrate and comprises at least one of silicon metal and silicon dioxide, said first layer is located on said bond layer and comprises at least one of pure mullite, mullite-barium strontium aluminosilicate, mullite-yttrium silicate and mullite-calcium aluminosilicate in an amount of between about 40 to 80 wt. % mullite and between about 20 to 60 wt. % barium strontium aluminosilicate, yttrium silicate or calcium aluminosilicate. The second layer of the EBC is located on the first layer of the EBC. The second layer consists essentially of barium strontium aluminosilicate. The system further comprises a thermal barrier coating (TBC) on the EBC. The thermal barrier coating includes up to about 9 mol percent of a stabilizer and up to 91 mol percent of primary oxide selected from the group consisting of zirconia, hafnia and mixtures thereof. The stabilizer comprises: a first metal oxide selected from the group consisting of yttria, calcia, ceria, scandia, magnesia, india and mixtures thereof, and a second metal oxide of a trivalent metal atom selected from the group consisting of lanthana, gadolinia, neodymia, samaria, dysprosia, ytterbia, erbia, and mixtures thereof. The first metal oxide is in amount of from about 3 to about 5 mol % and the second metal oxide is in an amount of from about 0.25 to about 6 mol %. The system also comprises a coefficient of thermal expansion (CTE) transition layer between said TBC and said EBC, said CTE transition layer having a CTE between that of the TBC and EBC.

In accordance with a further embodiment of the invention, a method for producing a thermal barrier coating/environmental barrier coating system on a substrate containing silicon is disclosed. The method comprises applying an environmental barrier coating (EBC) over said silicon substrate; and applying a thermal barrier coating (TBC) over the EBC. The thermal barrier coating includes up to about 9 mol percent of a stabilizer and up to 91 mol percent of primary oxide selected from the group consisting of zirconia, hafnia and mixtures thereof. The stabilizer comprises: a first metal oxide selected from the group consisting of yttria, calcia, ceria, scandia, magnesia, india and mixtures thereof, and a second metal oxide of a trivalent metal atom selected from the group consisting of lanthana, gadolinia, neodymia, samaria, dysprosia, ytterbia, erbia, and mixtures thereof. The first metal oxide is in amount of from about 3 to about 5 mol % and the second metal oxide is in an amount of from about 0.25 to about 6 mol %.

Other features and advantages will be apparent from the following more detailed description and drawings, which illustrate by way of example the principles of the invention.

### BRIEF DESCRIPTION OF THE DRAWINGS

FIG. 1 is a cross-sectional view of a gas turbine engine component formed of a Si-containing material and having a thermal/environmental barrier coating system, in accordance with an embodiment of the invention.

FIG. 2 shows a graph of TBC conductivity results.

FIG. 3 shows a graph of TBC coarse particle impact results.

FIG. 4 shows a graph of TBC fine particle erosion results.

### DETAILED DESCRIPTION OF THE INVENTION

Embodiments of the invention improve upon prior TBC/EBC systems used on silicon containing substrates. It does so by providing a thermal barrier coating which exhibits resistance to sintering, and lower thermal conductivity, thereby allowing the silicon substrate to operate at higher temperatures and also for longer durations than some conventional thermal barrier coatings such as YSZ used in prior TBC/EBC systems for application to silicon substrates. These systems also permit longer lives and/or thinner and lighter weight coatings for components. Advantageously, embodiments of the invention also optimize the combined properties of conductivity, mechanical properties and spallation resistance, and also can allow operation at temperatures up to 1704° C.

The TBC of embodiments of the invention may be used with any EBC known in the art used in conjunction with silicon based substrates applied to components operated within environments characterized by relatively high temperatures, and that are subjected to severe thermal cycling and stresses, oxidation, and corrosion. Some of the preferred TBC/EBC systems of the invention are described below.

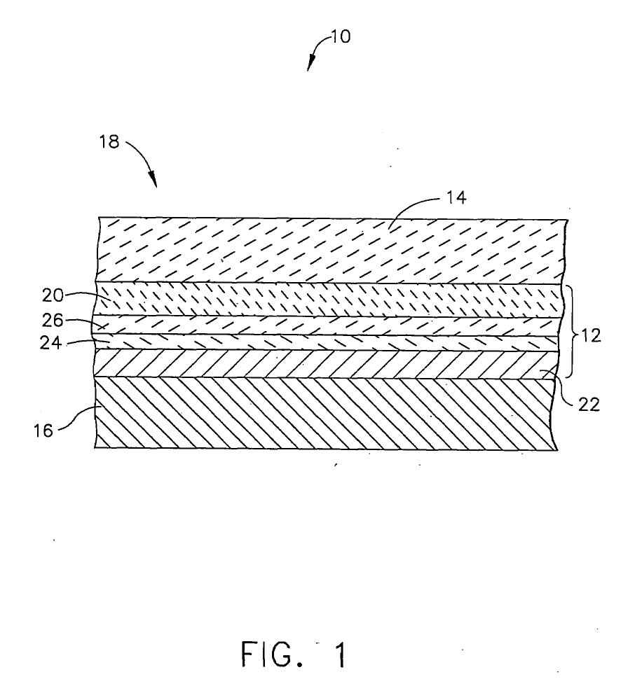

Referring to FIG. 1, a TBC/EBC system 10 of a first embodiment of the present invention is shown. The TBC/EBC system 10 includes an EBC 12, a TBC 14 or top coat and a surface region 16 or substrate of a hot section component 18. The TBC/EBC system of the first embodiment further comprises an optional CTE transition layer 20 in between the TBC 14 and EBC 12. The component 18, or at least the surface region 16 of the component 18, is formed of a silicon-containing material such as a SiC/SiC CMC, though the invention is generally applicable to other materials containing silicon in any form. Notable examples of such components include combustor components, turbine blades and vanes, and other hot section components of gas turbine engines.

The surface region 16 of the component 18 is protected by the multilayer TBC/EBC system 10 that includes the EBC 12 for providing environmental protection to the component 10 and a top coat or TBC 14 provided on top of the EBC for providing thermal insulation to the underlying CTE transition layer 20, EBC layer(s) 12 and component 18.

In accordance with an embodiment of the invention, the TBC 14 of the TBC/EBC system 10 comprises up to about 9 mol percent of a stabilizer and up to 91 mol percent of primary oxide selected from the group consisting of zirconia, hafnia and mixtures thereof. The stabilizer can comprise: a first metal oxide selected from the group consisting of yttria, calcia, ceria, scandia, magnesia, india and mixtures thereof and a second metal oxide of a trivalent metal atom selected from the group consisting of lanthana, gadolinia, neodymia, samaria, dysprosia, ytterbia, erbia, and mixtures thereof. The first metal oxide can be in amount of from about 3 to about 5 mol % and the second metal oxide can be in an amount of from about 0.25 to about 6 mol %.

A suitable thickness range for the TBC 14 is about 12.5 to about 1250 microns (about 0.0005 to about 0.050 inch), with a preferred range of about 75 to about 750 microns (about 0.003 to about 0.030 inch), depending on the particular application. Advantageously, the thickness of the TBC 14 may be tailored depending on the desired operational temperature. For example, the TBC 14 may be applied at to a thickness between about 12.5 microns and about 250 microns for operation in the range of about 2500-3000° F. (1371-1649° C.), whereas a thickness between about 125 microns and about 500 microns may be suitable for operations greater than about 3000° F. (1649° C.)

In forming the TBC/EBC system 10 according to an embodiment of the invention, the TBC 14 is applied on top of the EBC 12 for thermally insulating the underlying layer(s) of the EBC 12 and the component 18. Any EBC known in the art for use with silicon based substrates may be used in accordance with the TBC 14 in forming the TBC/EBC system 10. Nevertheless, there are certain EBC's which may be more advantageous for use with the TBC 14, depending upon the application for which the TBC/EBC is being used. For example, the TBC/EBC system 10 of the first embodiment depicted FIG. 1, has a multilayered EBC 12 with the CTE transition layer 20 between the TBC 14 layer and EBC 12. The layer 20 may have a CTE between that of TBC 14 and EBC 12. The TBC/EBC system 10 embodiment provides effective thermal and environmental protection to components having silicon based substrates operating at temperatures, such as between about 2500-3000° F. (1371-1649° F.), as well as about 3000° F. (1649° C.) or higher over numerous thermal cycles. In this embodiment, the CTE transition layer 20 preferably has a CTE between that of the TBC 14 and EBC 12, and also plays a helpful role in allowing the operation of the component 18 (e.g. gas turbine engine component) under the above described higher temperature conditions by providing a CTE match between the TBC 14 and EBC layers 12. This prevents spallation and debonding of the TBC/EBC coating system 10 which may occur in prior art coating systems under elevated temperatures due to CTE mismatch between the layers.

The multi-layered EBC 12 of the TBC/EBC system 10 of the first embodiment, preferably has three layers as shown in FIG. 1. These three layers of the EBC preferably include a bond layer 22, a first layer 24 and a second layer 26. The bond layer 22 overlays the silicon substrate 16 of the component 18 and preferably comprises at least one of silicon metal and silicon dioxide. The first layer 24 is located on the bond layer 22 and preferably comprises mullite-barrium strontium aluminosilicate in an amount of between about 40 to 80 wt. % mullite and between about 20 to 60 wt. % BSAS. Further, the second layer 26 of the EBC 12 preferably consists essentially of BSAS. Moreover, the CTE transaction layer 20 located in between the TBC 14 and EBC 12 may comprise a TBC matching CTE portion together with an EBC matching CTE portion. The TBC matching CTE portion may constitute up to 90 weight percent of the CTE transition layer. The TBC matching CTE portion preferably comprises yttria stabilized zirconia and mullite. The EBC matching CTE portion preferably comprises at least one of BSAS, mullite, alumina and any mixtures thereof. Different embodiments for the CTE transition layer are described in U.S. Pat. No. 6,444,334, and may all be used in accordance with embodiments described herein. It is noted that the TBC/EBC system of U.S. Pat. No. 6,444,334 may be used in accordance with embodiments of the invention, by substituting the TBC, i.e. YSZ of the '334 patent with the TBC 14 of the present invention and also by optionally substituting the YSZ material in the CTE transition layer of the '334 patent with the TBC materials of the present invention. The contents of U.S. Pat. No. 6,444,334 are hereby incorporated by reference.

Some notably preferred EBC's may be used in accordance with the TBC of the present invention for these applications as well. For instance, in another embodiment, a single layer EBC, comprised preferably of BSAS, as described in U.S. Pat. No. 5,985,470 could be used with the TBC 14 to form a TBC/EBC system which provides effective thermal and environmental protection to the underlying silicon based component. Further, in yet another embodiment of the present invention, one could also use a multi (e.g. two or three layered) EBC, as described in U.S. Pat. No. 6,410,148, wherein for example the EBC comprises a barrier layer comprising preferably B SAS and an intermediate layer, between the barrier layer and the substrate, preferably comprising mullite (40 to 80 wt %) with BSAS (20 to 60 wt. %) and optionally further comprising a bond coat layer comprising silicon in between the substrate and the intermediate layer. Similarly, the EBC 12 may comprise a rare earth silicate. For example, rare earth silicates, such as those described in U.S. Pat. No. 6,759,151 may be employed as the EBC 12 in place of the BSAS described herein. The contents of U.S. Pat. No. 6,759,151 are hereby incorporated by reference. As a further example, rare earth silicates include, but are not limited to, RE₂O₃.SiO₂, 2RE₂O₃.3SiO₂, RE₂O₃.2SiO₂, and combinations thereof, where RE is a rare earth element selected from the group consisting of Sc, Dy, Ho, Er, Tm, Yb, Lu, Eu, Gd, Th and combinations thereof.

As a further example, EBC 12 may comprise a multi-layer coating comprising a first layer 24 on the substrate and a second layer 26 overlying the first layer 24. The first layer 24 may comprise at least one of SiO₂, mullite, mullite barium strontium aluminosilicate, mullite-yttrium silicate, mullite calcium aluminosilicate, silicon metal and mixtures thereof, and the second layer 26 may comprise barium strontium aluminosilicate. The first layer 24 may consists essentially of mullite-barium strontium aluminosilicate in an amount of between about 40 to 80 wt. % mullite and between about 20 to 60 wt. % barium strontium aluminosilicate. The EBC 12 may further comprise a bond layer 22 between the substrate 16 and the first layer 24 of the EBC 12, the bond layer 22 comprising at least one of silicon metal and silicon dioxide. Similarly, as a further example, the CTE transition layer 20 may be comprised of a first and a second sublayer. The first sublayer may contact the EBC 12 and the second sublayer is located on the first sublayer and may comprise at least one of BSAS, mullite, alumina and any mixtures thereof. The CTE transition layer 20 may have a continuously changing composition, wherein the CTE transition layer has a decreasing concentration of an EBC matching CTE portion and an increasing concentration of a TBC matching CTE portion in a direction away from the EBC 12. The substrate 16 may be formed of a composite having a silicon carbide matrix.

Regardless of which EBC is used, the TBC 14 of embodiments of the invention can provide improved resistance to sintering, lower thermal conductivity and significantly reduced CTE compared to some conventional YSZ TBC's used to coat silicon based substrates. Moreover, these systems can advantageously have reduced weight and thickness in comparison to some prior systems while also balancing mechanical and spallation resistance properties.

The TBC 14 of the present invention can be deposited on the EBC 12 by any techniques known in the art, including plasma spraying and PVD techniques. Further, the EBC 12 of this invention can be deposited by air and vacuum plasma spraying (APS and VPS, respectively), though it is foreseeable that deposition could be performed by other known techniques, such as physical vapor deposition (PVD) and high velocity oxy-fuel (HVOF). Thereafter, a heat treatment may be performed after deposition of the EBC 12 and/or TBC 14 to relieve residual stresses created during cooling from elevated deposition temperatures.

Embodiments of the invention will now be described by way of example which is meant to be merely illustrative and thus nonlimiting.

### EXAMPLES

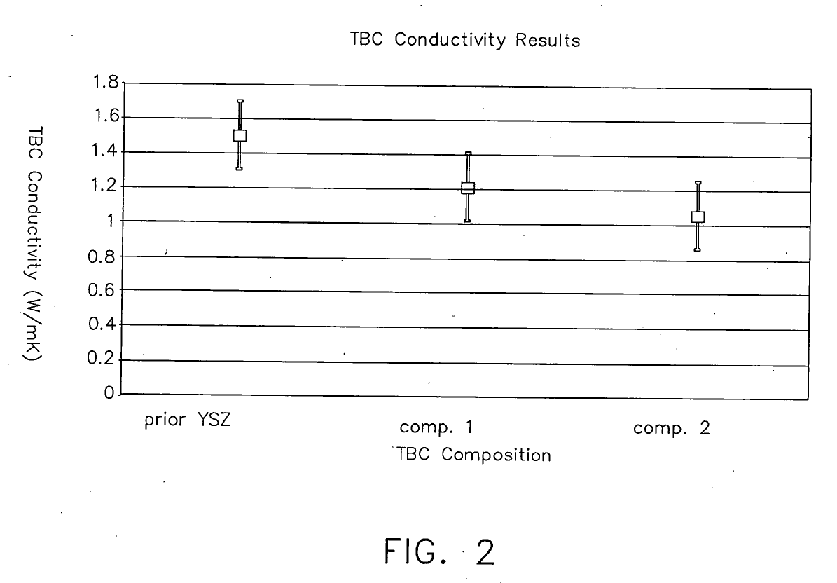

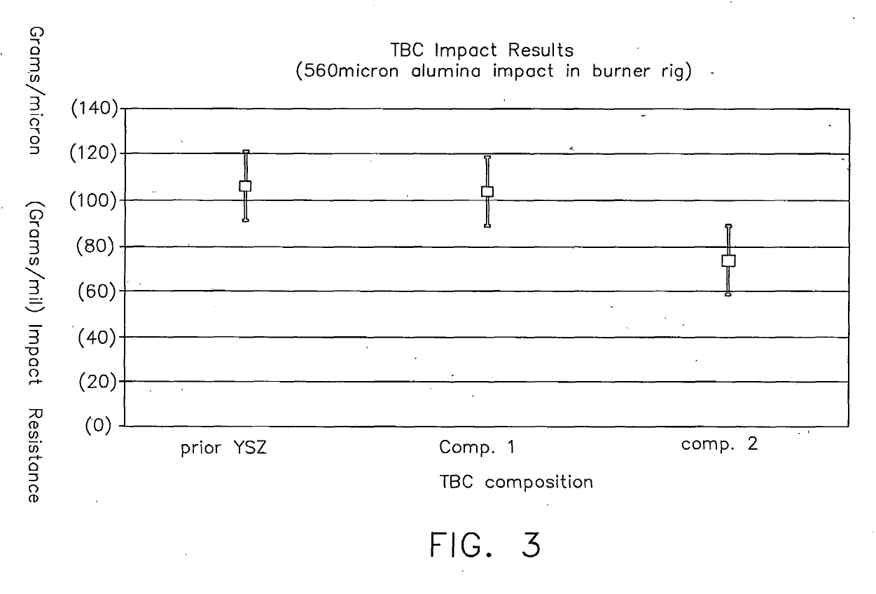

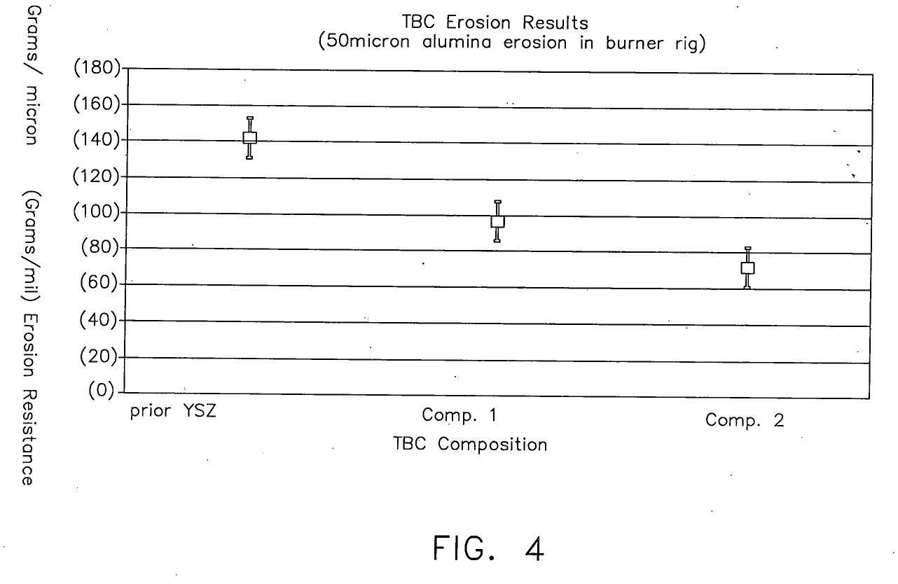

Conductivity, impact and erosion tests were performed on inventive samples, Comp 1 and Comp2, and compared with conventional TBC systems. These test results are illustrated in FIGS. 2-4, respectively. In particular, Comp1 is 95 mol % zirconia, 3.62 mol % yttria and 1.38 mol % lanthana, and Comp2 is 94 mol % zirconia, 4.80 mol % yttria and 1.20 mol % lanthana. The prior YSZ comparative composition is 7 wt % YSZ. Conductivity was performed by the laser flash method at a temperature of 860° C. for each sample after thermally aging the coating. The impact and erosion testing was conducted in a burner rig with a jet velocity on the order of Mach 0.5. For impact, 560 micron alumina was injected into the gas stream after combustion and for erosion, 50 micron alumina was injected. The “resistance” was measured as the weight of particulate to erode through the thickness of the TBC for each sample.

The above results advantageously demonstrate that embodiments of the invention had a significantly lower conductivity (e.g. up to about 20-30% lower) with reductions in the impact and erosion resistance.

While various embodiments are described herein it will be appreciated from the specification that various combinations of elements, variations or improvements may be made by those skilled in the art, and are within the scope of the invention.

1-26. (canceled)

27. A method for producing a thermal barrier coating/environmental barrier coating system on a substrate containing silicon comprising:
applying an environmental barrier coating (EBC) over said silicon substrate; and
applying a thermal barrier coating (TBC) over the EBC, said thermal barrier coating comprising up to about 9 mol percent of a stabilizer and up to 91 mol percent of primary oxide selected from the group consisting of zirconia, hafnia and mixtures thereof, wherein the stabilizer comprises:
a first metal oxide selected from the group consisting of yttria, calcia, ceria, scandia, magnesia, india and mixtures thereof,
a second metal oxide of a trivalent metal atom selected from the group consisting of lanthana, gadolinia, neodymia, samaria, dysprosia, ytterbia, erbia, and mixtures thereof;
wherein the first metal oxide is in an amount of from about 3 to about 5 mol %, the second metal oxide is in an amount of from about 0.25 to about 6 mol %.

28. The method of claim 27, wherein the thermal barrier coating comprises about 95 mol % zirconia, about 3.62 mol % yttria, and about 1.38 mol % lanthana.

29. The method of claim 27, wherein the thermal barrier coating comprises about 94 mol % zirconia, 4.8 mol % yttria, and about 1.2 mol % lanthana.

30. The method claim 27, wherein the second metal oxide is lanthana and ytterbia mixed in a ratio of from about 0.75 to about 1.33.
